(19) United States
(12) Patent Application Publication
(10) Pub. No.: US 2023/0341089 A1
(43) Pub. Date: Oct. 26, 2023

(54) INSTALLATION FOR STORING CRYOGENIC FLUID

(71) Applicant: L'Air Liquide, Société Anonyme pour l'Etude et l'Exploitation des Procédés Georges Claude, Paris (FR)

(72) Inventors: Guillaume PETITPAS, Coublevie, TX (US); Thomas POURBAIX, Jouy-en-Josas (FR)

(21) Appl. No.: 18/136,999

(22) Filed: Apr. 20, 2023

(30) Foreign Application Priority Data
Apr. 21, 2022 (FR) 2203704

(51) Int. Cl. F17C 3/00

(52) U.S. Cl. CPC F17C 3/005; F17C 2201/0104; F17C 2201/035; F17C 2203/0391; F17C 2221/012; F17C 2223/0161; F17C 2227/03; F17C 2270/0147

(57) ABSTRACT

An installation for storing cryogenic fluid, in particular liquefied hydrogen, including a cryogenic tank buried directly underground with a predetermined depth below the surface of the ground, having at least one heat transfer element having a thermal conductivity greater than 10 W/m.K and buried in the ground with a first end situated between the tank and the surface of the ground and a second end situated in a lateral zone around the tank.

### CROSS REFERENCE TO RELATED APPLICATIONS

This application claims the benefit of priority under 35 U.S.C. § 119 (a) and (b) to French Patent Application No. 2203704, filed Apr. 21, 2022, the entire contents of which are incorporated herein by reference.

### BACKGROUND

The invention relates to an installation for storing cryogenic fluid.

The invention relates more particularly to an installation for storing cryogenic fluid, in particular liquefied hydrogen, comprising a cryogenic tank buried directly underground with a predetermined depth below the surface of the ground.

Currently, the vast majority of the tanks in service stations for liquid fossil fuels (petrol/diesel) are buried, in direct contact with the earth (that is to say directly buried).

For “alternative” fuels (natural gas, hydrogen), the solutions remain currently unburied or housed in enclosures or vaults.

It has been observed that, when directly burying such a cryogenic tank in the ground, it is possible under certain conditions for a cold pocket to be formed between the top of the tank and the surface of the ground.

This effect is the result of the combination of the existence of low temperatures around the tank and of the presence of a thermal screen between the flow coming from the earth and the surface of the tank. This cold pocket potentially represents a risk for persons and equipment at ground level. Specifically, this may generate a local zone of frost or ice and a deterioration of equipment (cracking of civil engineering structures due to the occurrence of stresses caused by the differential swelling of the ground in the case of freezing of the latter, for example).

### SUMMARY

It is an object of the present invention to overcome all or some of the disadvantages of the prior art stated above.

To this end, the installation according to the invention, which is otherwise in accordance with the generic definition thereof given in the preamble above, is essentially characterized in that it comprises at least one heat transfer element having a thermal conductivity greater than 10 W/m. K and buried in the ground with a first end situated between the tank and the surface of the ground and a second end situated in a lateral zone around the tank.

Moreover, embodiments of the invention may comprise one or more of the following features:
the heat transfer element comprises at least one among: a beam, a fluid pipe for heat transfer fluid, a plate, a block, a fabric,
the heat transfer element is composed of at least one of the following materials: metal, alloy, aluminium, copper, steel (carbon and stainless steel), zinc, brass, nickel, iron, tin, bronze, carbon (in particular carbon or graphite or graphene fibre or carbon nanotubes),
the second end of the at least one transfer element is situated at a depth in the ground which is greater than the depth of the first end,
the second end of the at least one transfer element is situated at a depth corresponding to the depth of half the height of the tank,
the tank is buried to a depth of between 50 cm and 10 m,
the cryogenic tank is of the horizontal type, that is to say of oblong shape in which the longitudinal axis is horizontal, the installation comprising at least one transfer element distributed along the longitudinal direction of the tank.

The invention may also concern any alternative device or method comprising any combination of the features above or below within the scope of the claims.

Other particular features and advantages will become apparent upon reading the description below that has been given with reference to the figures.

### BRIEF DESCRIPTION OF THE FIGURES

The invention will be better understood on reading the following description given solely by way of example and with reference to the appended drawings, in which:

FIG. 1 is a schematic and partial view illustrating a possible exemplary embodiment of the invention.

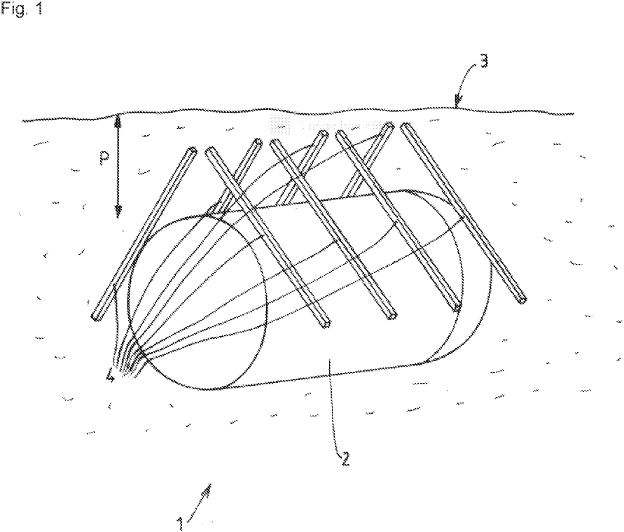

### DETAILED DESCRIPTION OF THE PREFERRED EMBODIMENTS

The illustrated installation 1 for storing cryogenic fluid, in particular for liquefied hydrogen, comprises a buried cryogenic tank 2. This tank of cryogenic type is configured to store a cryogenic fluid at a temperature of preferably below 173 K. This tank 2 is, for example, a tank with double walls whose inter-wall space is thermally insulated under vacuum.

The tank 2 is buried directly underground with a predetermined depth P below the surface of the ground 3. The term “buried directly” designates a burial without an enclosure or vault separating the tank from the earth (or sand or the like) in which it is buried. That is to say that the outer surface of the tank 2 can be in direct contact with the ground which surrounds it (or via an envelope, for example a flexible protective envelope).

For example, the tank 2 is buried to a depth P of between 50 cm and 10 m, for example a depth of between 1 and 3 m.

According to one advantageous particular feature, the installation 1 comprises at least one heat transfer element 4 having a thermal conductivity greater than 10 W/m.K and buried in the ground with a first end situated between the upper end of the tank 2 and the surface of the ground and a second end situated in a distinct zone around the tank 2. For example, the second end is situated at a depth corresponding to the depth of half the height of the tank 2.

Preferably, the second end of the transfer element 4 is situated at a depth in the ground which is greater than the depth of the first end.

This configuration allows the dissipation of the cold from the cold zone which may be situated between the top of a buried tank and the ground, using an element composed of a material having a greater thermal conductivity with respect to the conductivity of a surrounding dry ground.

This configuration reduces or eliminates the aforementioned disadvantages by homogenizing the range of temperatures around the buried tank 2.

This allows a direct burial with its advantages (footprint, cost, risk analysis, etc.).

The heat transfer element 4 may be composed, for example, of aluminium (thermal conductivity 200 W/m.K), copper (thermal conductivity 350 W/m.K), steel (thermal conductivity 50 W/m.K) or other material particularly having a conductivity greater than that of the dry earth (thermal conductivity of the order of 0.75 W/m.K).

In the example illustrated, the heat transfer element comprises a plurality of beams 4. More precisely, the installation 1 comprises a set of beams 4 made of material with a high thermal conductivity (aluminium, copper, etc.) that are buried in the upper part of the tank.

The cryogenic tank 2 may be of the horizontal type, that is to say of cylindrical shape with circular cross section and in which the longitudinal axis is horizontal.

The beams 4 are distributed along the longitudinal axis of the tank 2. As illustrated, the beams 4 may be arranged perpendicularly to a tangent to the surface of the tank 2. In such an arrangement, the beams 4 may be perpendicular to the temperature lines of the cold zone.

For example, these beams 4 may be spaced longitudinally from 5 cm to 200 cm. Their spacing is in particular intended to allow the passage of the water flows. Thermal dissipation then occurs by simple thermal conduction: the cold from the upper pocket of the ground is thus evacuated towards the hot zones, on the sides around the tank 2.

These beams or bars 4 may have a solid or hollow cross section that is square or circular or otherwise. These beams 4 may be installed directly in contact with the ground in order to promote thermal contact during the filling of a pit, for example with sand. The length and/or the cross section and the number of beams 4 may be dimensioned according to the requirements.

Likewise, all or some of these beams 4 may comprise branches to increase the exchange area between the ground and the conducting element.

Of course, the invention is not limited to this example. Thus, the beam or the beams 4 may be replaced or supplemented with other heat transfer elements, for example a heat transfer fluid circuit, solid or perforated plate(s), block(s), fabric(s), etc.

For example, two blocks (or “layers”) of heat-conducting material may be arranged in the same way as the two rows of beams 4 illustrated (one conducting block on each side of the tank 2). These blocks may be pierced with holes to avoid water accumulation problems. A simple sufficiently long fabric could also be considered.

In this description detailed above, the embodiments mentioned are examples. Although the description refers to one or more embodiments, that does not mean that the features apply only to a single embodiment. Simple features of various embodiments may also be combined and/or interchanged to provide other embodiments.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An installation for storing cryogenic fluid, comprising a cryogenic buried directly underground with a predetermined depth below the surface of the ground, further comprising at least one heat transfer element having a thermal conductivity greater than 10 W/m.K and buried in the ground with a first end situated between the tank and the surface of the ground and a second end situated in a lateral zone around the tank.

2. The installation according to claim 1, wherein the heat transfer element comprises at least one among: a beam, a fluid pipe for heat transfer fluid, a plate, a block, and a fabric.

3. The installation according to claim 1, wherein the heat transfer element is composed of at least one of the following materials: metal, alloy, aluminium, copper, steel (carbon and stainless steel), zinc, brass, nickel, iron, tin, bronze, and carbon.

4. The installation according to claim 1, wherein the second end of the at least one transfer element is situated at a depth in the ground which is greater than the depth of the first end.

5. The installation according to claim 1, wherein the second end of the at least one transfer element is situated at a depth corresponding to the depth of half the height of the tank.

6. The installation according to claim 1, wherein the tank is buried to a depth of between 50 cm and 10 m.

7. The installation according to claim 1, wherein the cryogenic tank is of the horizontal type, the installation comprising at least one transfer element distributed along the longitudinal direction of the tank.
